(19) United States
(12) Patent Application Publication
(10) Pub. No.: US 2006/0235927 A1
(43) Pub. Date: Oct. 19, 2006

(54) System and method for synchronizing distributed data streams for automating real-time navigation through presentation slides

(76) Inventors: Dharmesh N. Bhakta, Austin, TX (US); Trung Q. Ly, Austin, TX (US); Juan Francisco Obas, Austin, TX (US); Lakshmi N. Potluri, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/109,082

(22) Filed: Apr. 19, 2005

(51) Int. Cl. G06F 15/16

(52) U.S. Cl. 709/204

(57) ABSTRACT

A system and method for synchronizing distributed data streams for automating real-time navigation through presentation slides in an electronic conference are provided. With the system and method, a participant in an electronic conference is permitted to navigate back and forth through a series of presentation slides while being able to automatically synchronize the participant's display to a current position within the series of presentation slides regardless of which slide the participant's computer is currently displaying. The present invention provides a background mechanism for monitoring the current live presentation by a presenter during an electronic conference while a participant navigates through a local copy of the presentation slides. Upon the selection of a synchronization option, the participant's display output of the presentation slides is synchronized with the current live presentation using the background mechanism.

### BACKGROUND OF THE INVENTION

1. Technical Field

The present invention is generally directed to an improved data processing system. More specifically, the present invention is directed to an improved data processing system for controlling navigation through presentations during electronic conferencing.

2. Description of Related Art

The manner by which conferences between individuals are conducted has evolved with the evolution of computer applications from situations in which computer applications were used simply to prepare slides for printing and use with overhead projectors to the current technology in which the computers and computer applications themselves play an intimate role in conducting a web-conference/e-meeting. Today, entire conferences are conducted using computer applications to transmit data to participant computers in a local broadcast peer-to-peer manner. Moreover, today's computer technology has made possible the ability to conduct electronic conferences between individuals that are physically located at distant remote locations from one another.

With either local or remote participant electronic conferencing, following a presentation may sometimes not be as interactive as the participants would prefer. Sometimes participants would like to have the freedom to navigate back and forth through the presentation and up to the real time point of the presenter without interfering with other participants. However, with current technology, such freedom cannot be realized. For example, electronic whiteboards allow an electronic conference participant, with sufficient access rights, to alter the flow of a presentation by remotely controlling the desktop of the presenter. Such a solution results in conference participants altering the presentation for the other participants of the conference as well. Thus, one conference participant is permitted to interfere with the conference experience of every other conference participant, which may or may not be welcomed by the other participants.

In other systems, the presenter of the presentation during the electronic conference may distribute a soft copy of the presentation slides prior to conducting the electronic conference. In this way, each conference participant may have their own local copy of the presentation slides on their respective systems. If a participant needs to navigate back to a previous slide to clarify a point, he/she may just use the local copy of the presentation slides to do so without interfering with other conference participants. However, in such a case, there are no mechanisms for automatically returning to a current state of the presentation. On the contrary, in such systems, it is left to the participant to navigate back to a slide that the presenter is currently on. In electronic conferencing in which the participants are remotely located, this may be difficult to do since it may not be readily apparent from the discussion, what slide the presenter is currently on.

In other words, since the presenter and participant are no longer rigidly synchronized, such as in the electronic whiteboard mechanism described above, performing such synchronization becomes difficult and error prone. Therefore, it would be beneficial to have a system and method for synchronizing distributed data streams for automating real-time navigation through presentation slides.

### SUMMARY OF THE INVENTION

The present invention provides a system and method for synchronizing distributed data streams for automating real-time navigation through presentation slides in an electronic conference. With the system and method of the present invention, a participant in an electronic conference is permitted to navigate back and forth through a series of presentation slides while being able to automatically synchronize the participant's display to a current position of a presenter's computing device within the series of presentation slides regardless of which slide the participant's computer is currently displaying.

The present invention provides a background mechanism for monitoring the current live presentation by a presenter during an electronic conference while a participant navigates through a local copy of the presentation slides. Upon the selection of a synchronization option, the participant's display output of the presentation slides is synchronized with the current live presentation using the background mechanism so that the participant may immediately move to a current presentation slide being used by the presenter of the electronic conference regardless of which presentation slide the participant navigates to during his/her deviation from the live presentation.

In one exemplary embodiment of the present invention, a soft copy of the presentation slides is distributed to the electronic conference participants at some time prior to the electronic conference. During the electronic conference, the presenter's computing device need only transmit control data to the participant-computing devices to control the transition flow from one presentation slide to the next in the series of presentation slides. In this way, the participant-computing devices are synchronized with the presenter's computing device with regard to the presentation slide being displayed on each participant's computing device.

With the present invention, since each participant has a local copy of the presentation slides, each participant is permitted to deviate from the current flow of the presentation slides so that the participant may independently navigate through the local copy of presentation slides without interfering with the display of presentation slides on other participant-computing devices or the presenter's computing device. A graphical user interface is provided such that the participants are able to navigate through the local copy of the presentation slides. When the participant uses these controls to navigate independently through the local copy of the presentation slides, the participant-computing device transitions to a non-synchronized mode of operation.

In such a mode of operation, a separate background application thread is utilized to maintain background synchronization with the presenter's live presentation and current state of the presentation slides. Thus, with the background application thread, synchronization is maintained while in a foreground application thread, the participant is permitted to navigate through the presentation slides in a non-synchronized manner. Upon selection by the participant, the current state of the background application thread is used to update the foreground application thread so as to automatically synchronize the foreground application thread with the current state of the live presentation. As a result, the background application thread is brought to the foreground and the previously non-synchronized foreground application thread is torn down.

In further embodiments of the present invention, controls are provided via a graphical user interface of a presenter's computing device to inhibit the independent navigation of participant-computing devices through the presentation slides. Other controls that may be included include a synchronization control that forces all participant-computing devices to immediately become synchronized with the presenter's currently displayed presentation slide regardless of the current state of each individual participant's displayed presentation slide. Moreover, the presenter may be provided with a similar non-synchronized mode of operation in which the presenter may independently navigation through the presentation slides without interfering with the currently displayed presentation slides of the participant-computing devices. Still further, in other embodiments, the presentation slides may be transmitted to each participant-computing device upon presentation by the presenter-computing device such that independent navigation of presentation slides on the participant-computing devices is limited to those that have been transmitted to the participant-computing devices.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a data processing system in which aspects of the present invention may be implemented;

FIG. 2 is an exemplary block diagram of a server computing device in which aspects of the present invention may be implemented;

FIG. 3 is an exemplary block diagram of a client computing device in which aspects of the present invention may be implemented;

FIG. 4 is an exemplary diagram illustrating the primary operational components of a presenter data processing system in accordance with one exemplary embodiment of the present invention;

FIG. 5 is an exemplary diagram illustrating the primary operational components of a participant data processing system in accordance with one exemplary embodiment of the present invention;

FIG. 6 is an exemplary diagram illustrating the use of a parent thread and a child thread to permit independent local navigation/access of presentation data while maintaining synchronization with a presenter-computing device in accordance with one exemplary embodiment of the present invention;

FIG. 7 is a flowchart outlining an exemplary operation of a presenter data processing system in accordance with one exemplary embodiment of the present invention; and

FIG. 8 is a flowchart outlining an exemplary operation of a participant data processing system in accordance with one exemplary embodiment of the present invention.

### DETAILED DESCRIPTION OF THE PREFERRED EMBODIMENT

The present invention provides a mechanism for synchronizing the display of presentation slides during an electronic conference while permitting individual participants to independently navigate through the series of presentation slides. As such, the present invention may be applied to electronic conferences in which the presenter and each participant are present in close proximity to one another, such as in the same room of a building. In addition, the present invention may be applied to electronic conferences which are conducted between remotely located participants, such as an electronic conference conducted over the Internet or other network in which participants may not be in close proximity to one another. Of course, an electronic conference in which a combination of close and remotely located participants are involved may also make use of the mechanisms of the present invention.

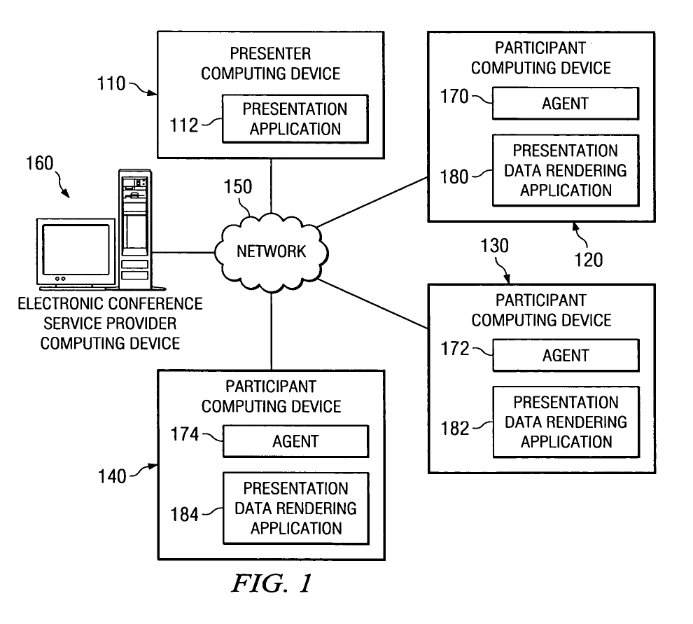

FIG. 1 is an exemplary block diagram of a data processing system in which aspects of the present invention may be implemented. AS shown in FIG. 1, the data processing system includes the presenter-computing device 110 and a plurality of participant-computing devices 120-140. The presenter-computing device 110 and participant-computing devices 120-140 are coupled to one another via one or more networks 150. The one or more networks 150 may include a local area network (LAN), wide area network (WAN), the Internet, intranets, and the like.

The computing devices 110-140 may be coupled to the one or more networks 150 via communication links which may be either wired or wireless communication links. In one exemplary embodiment of the present invention, the one or more networks 150 include a wireless network in which the computing devices 110-140 communicate with one another via wireless communication links. In addition, the one or more networks 150 may include routers, switches, and other known network mechanisms for routing data communications between computing devices.

With the present invention, in order to conduct an electronic conference, i.e. a conference in which the presentation slides and/or other materials being presented are distributed to conference participants in an electronic format as presentation data to the participants' computing devices, each participant in the electronic conference must register their participant-computing device 120-140 with the presenter-computing device 110 or with a electronic conference service provider computing device 160 that may be part of the one or more networks 150. That is, in one embodiment, the presenter-computing device 110 is responsible for registering participant-computing devices and controlling the distribution of data to these registered participant-computing devices. In another embodiment, the participant-computing devices 120-140 and the presenter-computing device 110 register with an electronic conference service provider computing device 160 that coordinates the distribution of data between the computing devices 110-140.

In either embodiment, the presenter-computing device 110 includes a presentation application 112 that is responsible for sending control signals and/or data to each of the participant-computing devices for controlling the display of presentation data, such as presentation slides, on each of the participant-computing devices 120-140. These control signals and/or data are transmitted by the presentation application 112 of the presenter-computing device 110 via one or more communication links of the one or more networks 150 to the participant-computing devices 120-140 either directly or via an electronic conference service provider computing device 160. The presentation data, e.g., presentation slides, may be distributed to the participant-computing devices 120-140 at some time prior to the electronic conference or may be transmitted to the participant-computing devices 120-140 during the electronic conference as the presenter-computing device 110 transitions from one portion of presentation data to a next portion of the presentation data, e.g., from one electronic presentation slide to the next.

Thus, in one exemplary embodiment of the present invention, all of the presentation data is resident on the participant-computing devices 120-140 as a local copy prior to the electronic conference. In another embodiment, the presentation data is transmitted to the participant-computing devices such that only the portion of presentation data currently being accessed by the presenter-computing device is transmitted to the participant-computing devices.

The presenter-computing device 110 transmits control signals to the participant-computing devices 120-140 either directly or via an electronic conference service provider computing device 160. The control signals are used to control the accessing of presentation data on each of the participant-computing devices 120-140. Thus, in an exemplary embodiment in which the presentation data is presentation slides being displayed on each of the participant-computing devices 120-140, the control signals are used to designate which presentation slide is currently being displayed by the presenter-computing device 110. Other control signals may include control signals for inhibiting independent navigation of the presentation data on the participant-computing devices 120-140, forcing synchronization of presentation data on each of the participant-computing devices 120-140, and other types of control signals which will be described in greater detail hereafter.

An agent 170-174 executing on the participant-computing devices 120-140 provides an interface through which the control signals from the presenter-computing device 110 are received and processed to control the operation of the presentation data rendering application 180-184 on the participant-computing devices 120-140. These agents 170-174 may be applications, applets, plug-in modules, or the like, that provide functionality for synchronizing access to presentation data with the presenter-computing device 110. In addition, the agents 170-174 provide a mechanism for providing independent navigation and access of the presentation data on each participant-computing device 120-140 as well a graphical user interface controls for permitting users of the participant-computing devices 120-140 to perform such independent navigation and synchronization.

During a normal synchronized mode of operation, the presenter-computing device 110 sends control signals to each of the participant-computing devices 120-140 indicating which portion of the presentation data is currently being accessed by the presenter-computing device 110, e.g., which presentation slide is currently being displayed on the presenter-computing device 110. These control signals are received by the agents 170-174 which interface with the presentation data rendering applications 180-184 to cause the same portion of presentation data to be accessed on each of the participant-computing devices 120-140. As the presenter-computing device 110 transitions to accessing other portions of the presentation data, similar control signals are sent to participant-computing devices 120-140 to maintain synchronization between the computing devices 110-140. Such synchronization may be facilitated by metadata associated with the portions of presentation data so that the control signals identify the metadata corresponding to the portion or presentation data being accessed by the presenter-computing device 110 and the agents 170-174 cause the same portion of presentation data, as determined by metadata of local copies of the presentation data, are accessed on the participant-computing devices 120-140.

As mentioned above, the present invention further permits the users of the participant-computing devices 120-140 to independently navigate or access portions of the presentation data that are not currently being accessed by the presenter-computing device 110. For example, a user of a participant-computing device 120 may navigate back and forth through a series of presentation slides during the electronic conference even though the presenter-computing device 110 remains on a same presentation slide. Thus, the user may transition from slide 4 to slide 5 and then back to slide 3 while the presenter-computing device 110 remains on slide 4, for example.

Controls for such navigation may be presented to the user of the participant-computing device 120-140 as graphical user interface controls present on the presentation data rendering applications 180-184. Upon selection of a presentation data navigation control by a user of a participant-computing device 120-140, the participant-computing device 120-140 transitions from a synchronized mode of operation to a non-synchronized mode of operation. This transition involves the spawning of a child thread and a thread context switch from the parent thread, which is used to maintain synchronization with the presenter-computing device 110, to the child thread. The child thread is used to provide independent local navigation and access to the presentation data while the parent thread is used to maintain the synchronization with the presenter-computing device 110.

With the child thread, a similar graphical user interface and/or presentation data rendering application instance, as is provided by the parent thread, is generated for permitting independent local navigation/access of the presentation data. Thus, the user of the participant-computing device 120-140 navigates through and accesses portions of the local copy of the presentation data using the graphical user interface controls of the graphical user interface. At the same time, as a background operation, the parent thread continues to maintain synchronization with the presenter-computing device 110 by receiving control signals from the presenter-computing device 110 and processing them to determine the current state of the presentation data rendering application 180-184 in a synchronized mode of operation. While the parent thread maintains this synchronization, the actual presentation data output perceived by the user of the participant-computing device 120-140 is the output generated by the child thread.

In addition to the graphical user interface controls provided by the presentation data rendering application 180-184 as part of the parent thread, in the child thread, the graphical user interface may further include a synchronize control. The synchronize control may be selected by a user of the participant-computing device 120-140 to switch the thread context back to the parent thread such that the parent thread is no longer operating as a background process but is brought to the foreground and the child thread is torn down.

As discussed above, in one embodiment of the present invention, the presentation application 112 of the presenter-computing device 110 includes additional controls for controlling the access of presentation data by the participant-computing devices 120-140. The presentation application 112 may provide graphical user interface controls that may be selected by a user of the presenter-computing device 110 to initiate these additional controls.

One such control includes an inhibit control that is used to inhibit the independent navigation/access of the presentation data on the participant-computing devices 120-140. For example, a user of the presenter-computing device 110 may determine that the particular points being covered by the user and represented in the particular portion of the presentation data being accessed by the presenter-computing device 110 are of such an important nature that the user wishes to bring the participants' attention to it regardless of where they currently are in their independent navigation/access of the presentation data. In such a case, the user of the presenter-computing device 110 may select a control via the presentation application 112 of the presenter-computing device 110 to send out a control signal to each of the participant-computing devices 120-140 inhibiting independent navigation/access of the presentation data. In response, the navigation/access controls of the agents 170-174 resident on the participant-computing devices 120-140 may be inhibited and grayed-out so that the users of the participant-computing devices 120-140 may not select these controls.

Moreover, in response to such a control signal, the agents 170-174 may initiate an immediate thread context switch between any child thread and its corresponding parent thread so that the parent thread is brought to the foreground. As a result, the current portion of the presentation data being accessed by the presenter-computing device 110 is immediately accessed by each of the participant-computing devices 120-140.

While this control signal results in a thread context switch on each of the participant-computing devices 120-140, it is not necessary to tear down the child thread. On the contrary, the child thread may be sent to the background so that when the inhibit state initiated by the user of the presenter-computing device releases the inhibit state, a thread context switch may be made to restore the child thread to the foreground and move the parent thread back to the background. Thus, the inhibit control signal is used to inhibit independent navigation/access of the presentation data as well as perform a thread context switch between the parent thread and the child thread. In this way, the user of the presenter-computing device 110 may remotely control the output on each of the participant-computing devices 120-140 in an override operation that overrides the local independent navigation/access of the presentation data by the users of the participant-computing devices 120-140.

As a further control of the presentation application 112 on the presenter-computing device 110, the user may be provided with a control to force the participant-computing devices to perform a thread context switch between the child and parent threads so as to immediately change the output of the participant-computing devices 120-140 to be the output of the parent thread. This control is similar to the inhibit control discussed above but without the inhibiting of the local controls in the agents 170-174 to independently navigation/access the presentation data.

In a further embodiment of the present invention, the presentation application 112 on the presenter-computing device 110 is provided with the same independent navigation/access of the presentation data as is provide by the agents 170-174 of the participant-computing devices 120-140. That is, the user of the presenter-computing device 110 may select a graphical user interface control provided by the presentation application 112 to independently navigate/access portions of the presentation data without affecting the current portion of the presentation data being accessed by the participant-computing devices 120-140. In this way, a user of the presenter-computing device 110 may search for portions of the presentation data that are of interest to the user without interfering with the portion of the presentation data being accessed by the participant-computing devices 120-140. For example, a presenter of a slide based presentation may flip through the slides electronically looking for a slide of interest while the participants still view the last slide output by the presenter-computing device 110 before initiation of the local non-synchronized navigation of the slides by the presenter-computing device 110.

The above description of the exemplary embodiments of the present invention has been provided with the assumption that the entire set of presentation data is distributed to the participant-computing devices 120-140 prior to a start of the electronic conference. In this way, the users of the participant-computing devices 120-140 are free to navigate/access all portions of the presentation data locally without interfering with the navigation/access of the presentation data on other participant-computing devices 120-140 or on the presenter-computing device 110. As mentioned previously, however, the present invention is not limited to such embodiments.

On the contrary, rather than distributing all of the presentation data prior to the electronic conference, the presentation data may be transmitted by the presenter-computing device 110 piecemeal as the presenter-computing device 110 navigates/accesses the presentation data. That is, with the control signals being sent by the presenter-computing device 110, the actual portion of presentation data corresponding to the control signal may also be transmitted to each of the participant-computing devices 120-140. This eliminates the need to distribute a full copy of the presentation data to each of the participant-computing devices 120-140 a priori.

With such an embodiment, however, the independent local navigation/access of the presentation data on the participant-computing devices 120-140 in a non-synchronized mode is limited to the portions of presentation data that have already been received. Thus, the independent navigation/accessing of the presentation data may be limited to the last portion of the presentation data received by the participant-computing device 120-140 and any previously received portions of the presentation data that may be stored locally. For example, if the presenter-computing device 110 has only navigated through slides 1-10 of a presentation, the participant-computing devices 120-140 would not be able to independently navigate to slide 12 since the presentation data for slide 12 has not yet been transmitted by the presenter-computing device 110.

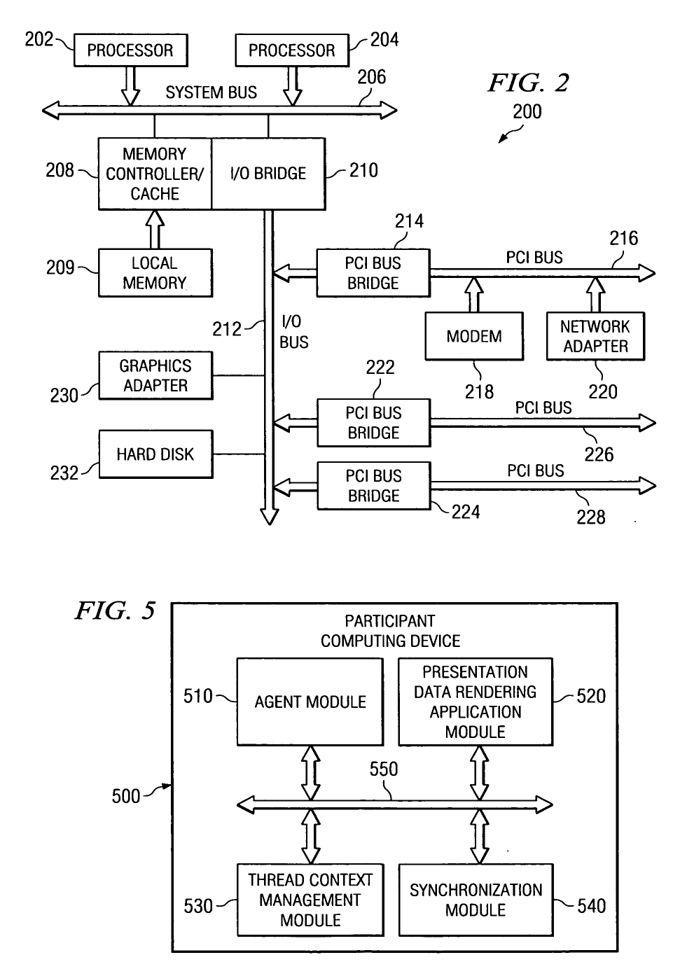

Other modifications to the types of controls that may be provided to the user of the presenter-computing device 110 and/or the participant-computing devices 120-140 may be made without departing from the spirit and scope of the present invention. Having described the overall interaction between computing devices in accordance with exemplary embodiments of the present invention, the following FIGS. 2 and 3 are provided as examples of computing device upon which aspects of the present invention may be implemented.

FIG. 2 is an exemplary block diagram of a server-computing device in which aspects of the present invention may be implemented. The server-computing device shown in FIG. 2 may be used to implement a presenter-computing device, such as presenter-computing device 110, an electronic conference service provider computing device, such as electronic conference service provider computing device 160, or the like.

Referring now to FIG. 2, data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to client computing devices, such as presenter-computing device 110 and/or participant-computing devices 120-140 in FIG. 1, may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

FIG. 3 is an exemplary block diagram of a client computing device in which aspects of the present invention may be implemented. The client computing device shown in FIG. 3 may be used to implement the presenter-computing device 110 and/or the participant-computing devices 120-140 of FIG. 1, for example. As shown in FIG. 3, data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards.

In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

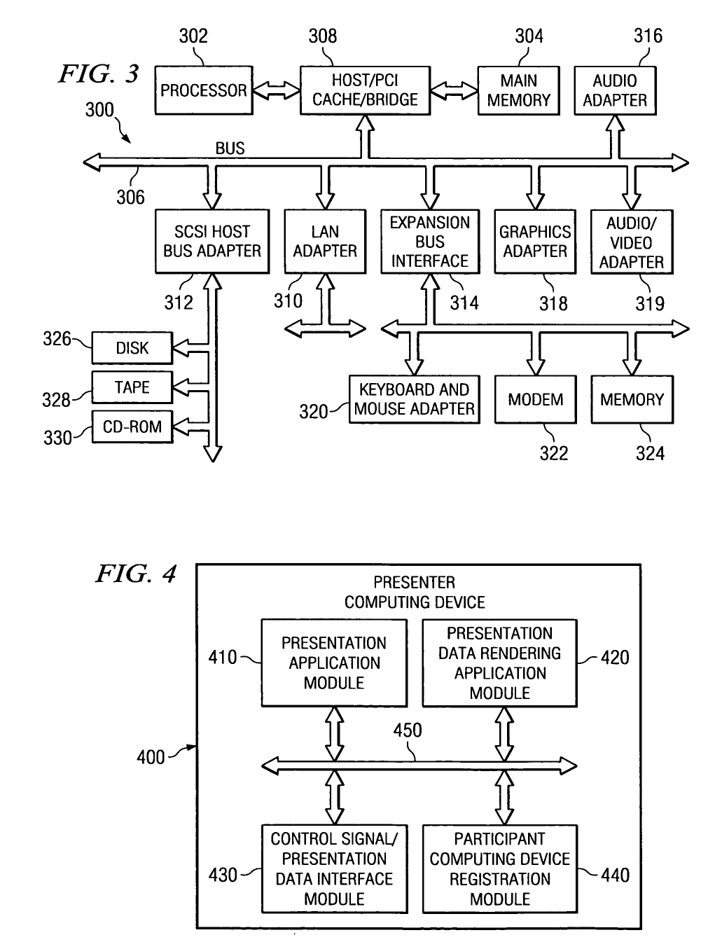

FIG. 4 is an exemplary diagram illustrating the primary operational components of a presenter-computing device in accordance with one exemplary embodiment of the present invention. As shown in FIG. 4 the presenter-computing device 400 includes a presentation application module 410, a presentation data rendering application module 420, a control signal/presentation data transmission interface module 430, and a participant-computing device registration module 440. These elements 410-440 may communicate with one another via a control/data signal bus 450, for example. Although bus architecture is shown in FIG. 4, the present invention is not limited to such and any mechanisms that facilitates the communication of control signals/data between the elements 410-440 may be used without departing from the spirit and scope of the present invention.

The participant-computing device registration module 440 is used to register participant-computing devices for inclusion in an electronic conference so that these participant-computing devices may receive control signals and/or presentation data during the electronic conference. Registration of the participant-computing devices may involve using security mechanisms, such as password or passcode verification, and the like, to ensure that those participant-computing devices that are registered for the electronic conference are indeed permitted to be part of the electronic conference. In addition, upon registration, the presenter-computing device may transmit a copy of the presentation data to the recently registered participant-computing device so that the participant-computing device stores a copy of the presentation data locally for use during the electronic conference.

The information maintained by the participant-computing device registration module 440 for each of the participant-computing devices includes address information for directing data transmissions to the registered participant-computing devices. This address information may be, for example, a network address or the like. This information is used to direct control signals and/or presentation data to the registered participant-computing devices during the electronic conference.

The presentation application module 410 provides the primary functionality of the present invention with regard to the presenter-computing device. That is, the presentation application module 410 provides the graphical user interface through which the user of the presenter-computing device may select controls specific to the present invention. In addition, the presentation data rendering application module 420, whose responsibility it is to render the presentation data on the presenter-computing device. When the user navigates through or accesses different portions of the presentation data, the presentation data rendering application module 420 renders these different portions of the presentation data as well as communicates with the presentation application module 410 to identify the current portion of the presentation data being accessed.

The presentation application module 410 then communicates with the control signal/presentation data transmission interface module 430 to thereby generate control signals/presentation data to be transmitted to each of the registered participant-computing devices, as determined from the participant-computing device registration module 440. Control signals/presentation data may also be generated in response to a user selection of a graphical user interface control via the presentation application module 410.

FIG. 5 is an exemplary diagram illustrating the primary operational components of a participant-computing device in accordance with one exemplary embodiment of the present invention. As shown in FIG. 5, the participant-computing device 500 includes an agent module 510, a presentation data rendering application module 520, a thread context management module 530, and a synchronization module 540. The elements 510-540 may be in communication with one another via the control/data signal bus 550, for example, although a bus architecture is not necessary to the operation of the present invention and other architectures may be utilized.

The agent module 510 provides a communication interface through which the participant-computing device communicates with the presenter-computing device. The agent module 510 sends requests for information to the presenter-computing device and receives control signals/presentation data from the presenter-computing device. The agent module 510 further controls the operation of the other elements 520-540 based on the information, control signals and presentation data received from the presenter-computing device.

The agent module 510 sends a request to the presenter-computing device to register the participant-computing device for inclusion in the electronic conference. In addition, the agent module 510 requests whether or not the presenter-computing device has already started the presentation for the electronic conference. If not, no additional operations are necessary at that time until the presentation is initiated by the presenter-computing device. If the presenter-computing device has already initiated the presentation, the agent module 510 then requests the identity, e.g., the metadata, of the current portion of the presentation data being accessed by the presenter-computing device. In embodiments in which the presentation data is transmitted to the participant-computing devices as the presenter-computing device navigates through the presentation data, the presentation data transmitted prior to the current portion being accessed may also be transmitted to the participant-computing device.

Thereafter, control is handed over to the synchronization module 540 for maintaining synchronization between the participant-computing device and the presenter-computing device. Control signals received from the presenter-computing device are processed by the synchronization module 540 which then interfaces with the presentation data rendering application module 520 to control the output of the participant-computing device to correspond to the current output of the presenter-computing device, e.g., the displayed presentation slide being displayed by the presenter-computing device.

In addition, the agent module 510 monitors for a user selection of a graphical user interface control for independently navigating/accessing the presentation data. In response to a selection of such a control, the agent module 510 spawns a child thread used to permit the independent navigation/access of the presentation data. The parent thread is permitted to continue operation in a background so as to maintain synchronization with the presenter-computing device. The thread context manager module 530 is used to manage these threads and switching between these thread contexts in response to control signals received from the presenter-computing device or selection of a control by a user of the participant-computing device to return to a synchronized mode of operation.

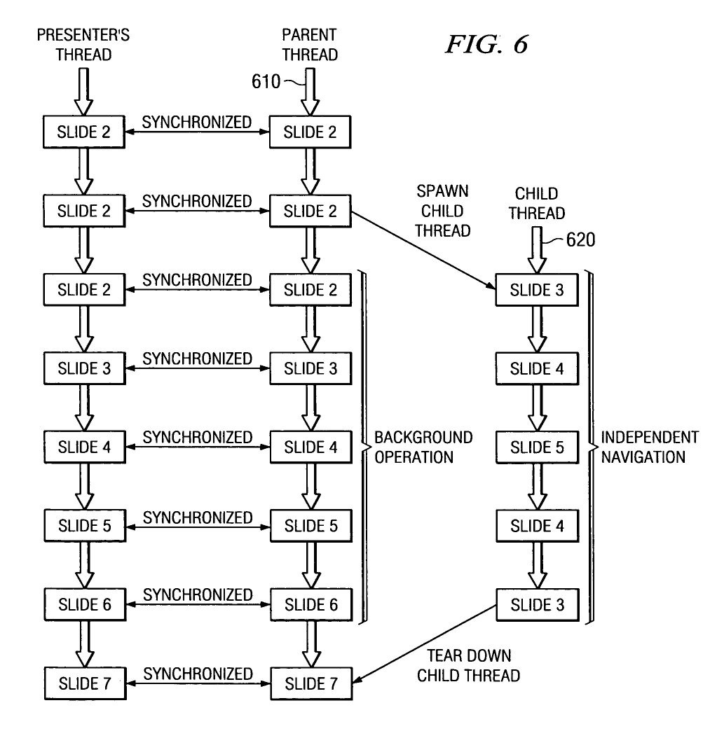

FIG. 6 is an exemplary diagram illustrating the use of a parent thread and a child thread to permit independent local navigation/access of presentation data while maintaining synchronization with a presenter-computing device in accordance with one exemplary embodiment of the present invention. As shown in FIG. 6, initially a parent thread provides a synchronized display of presentation data. That is, in the depicted example, the presenter-computing device is currently outputting presentation slide 2 and thus, through the synchronization mechanisms of the present invention, the parent thread 610 processes control signals from the presenter-computing device to thereby synchronize the output generated by the parent thread to output presentation slide 2 as well.

At some time later, while the presenter-computing device is still outputting presentation slide 2, the user of the participant-computing device chooses to independently navigate the presentation slides in a non-synchronized manner. As a result, child thread 620 is spawned that permits the user of the participant-computing device to navigate to presentation slides 3 through 5. During this independent navigation, the parent thread 610 continues to maintain synchronization with the presenter-computing device as the presenter-computing device transitions to slides 3 and 4.

At some time later, the user of the participant-computing device selects to return to a synchronized mode of operation. As a result, the child thread 620 is torn down and the output of the participant-computing device is switched to the output of the parent thread 610, e.g., presentation slide 7.

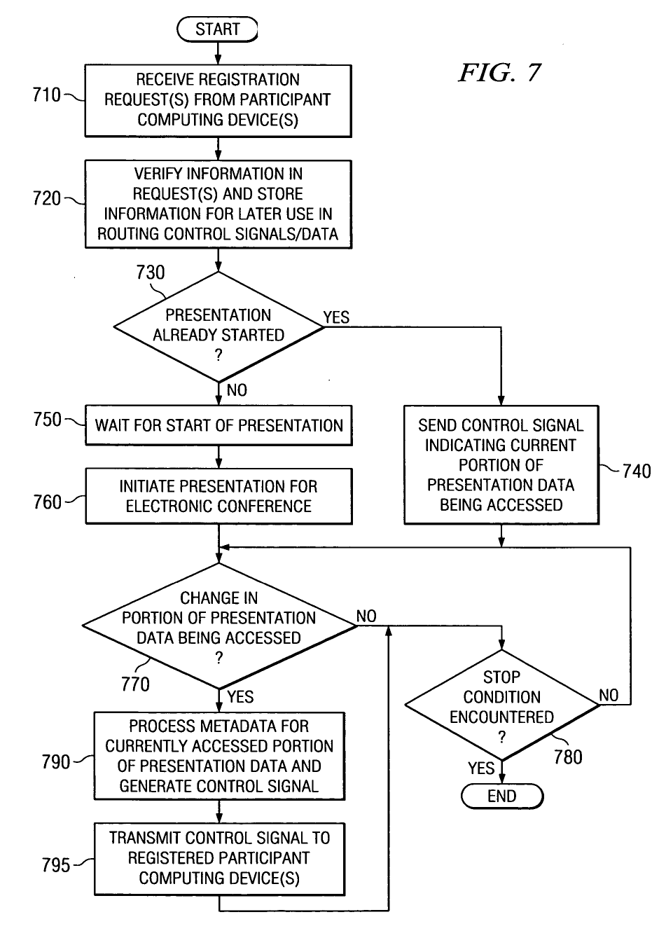

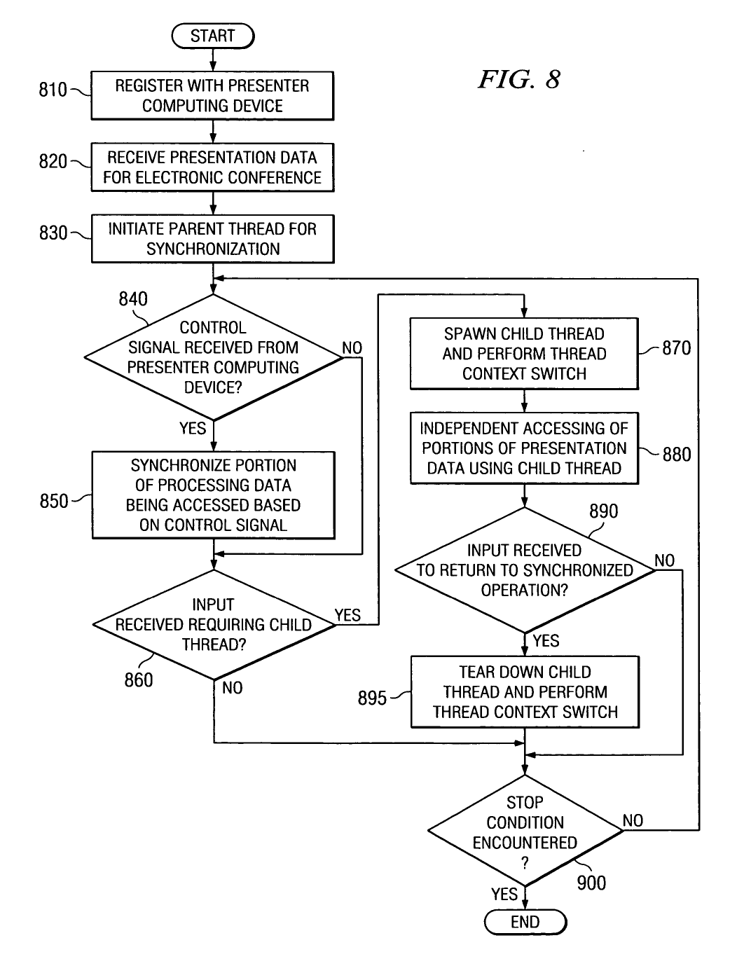

FIGS. 7 and 8 are flowcharts that illustrate exemplary operations of a presenter-computing device and participant-computing device, respectively, according to the invention. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

FIG. 7 is a flowchart outlining an exemplary operation of a presenter data processing system in accordance with one exemplary embodiment of the present invention. As shown in FIG. 7, the operation starts by receiving one or more registration requests from participant-computing devices (step 710). The information submitted in the registration requests is verified and address information for verified participant-computing devices is stored for later use in routing control signals and/or presentation data to the registered participant-computing devices (step 720). In addition, presentation data may be transmitted to the newly registered participant-computing devices.

A determination as to whether the presentation for the electronic conference has already started or not is made (step 730). If the presentation has started, a control signal indicating the current portion of presentation data being accessed by the presenter-computing device is generated and transmitted to the newly registered participant-computing device(s) (step 740). If the presentation has not already started, the operation waits for the start of the presentation (step 750).

At some time later, the presentation for the electronic conference is then initiated (step 760). A determination as to whether a change in the portion of presentation data that is being accessed has occurred (step 770). If not, then a determination is made as to whether a stop condition has occurred, e.g., closing the presentation application or otherwise indicating an end to the presentation and accessing of presentation data (step 780). If not, the operation returns to step 770 and continues to wait for a change in the portion of presentation data being access or a stop condition. If a stop condition has occurred, then the operation terminates.

If there has been a change in the portion of presentation data being accessed, the metadata for the currently accessed portion of the presentation data is processed and a control signal is generated based on this metadata (step 790). The control signal includes a command to access the same portion of presentation data on participant-computing devices. This control signal is then transmitted to each of the registered participant-computing devices (step 795). The operation then returns to step 770 and waits for either another change in the portion of presentation data being accessed or a stop condition.

FIG. 8 is a flowchart outlining an exemplary operation of a participant data processing system in accordance with one exemplary embodiment of the present invention. As shown in FIG. 8, the operation starts with the participant-computing device registering with a presenter-computing device to be a participant in an electronic conference (step 810). Thereafter, presentation data for the electronic conference is received from the presenter-computing device (step 820). While FIG. 8 shows the presentation data being received after registration, the present invention is not limited to such and the presentation data may be received prior to registration or piecemeal during the actual electronic conference as previously described above.

A parent thread is initiated for synchronizing access to portions of the presentation data with the presenter-computing device (step 830). A determination is made as to whether a control signal is received from the presenter-computing device indicating a change in the portion of presentation data being accessed by the presenter-computing device (step 840). If so, then the portion of presentation data being accessed locally is synchronized based on the control signal (step 850).

If a control signal is not received, a determination is made as to whether an input is received that requires a child thread to be spawned so that independent accessing of portions of the presentation data may be performed (step 860). If so, a child thread is spawned and the thread context is switched such that the child thread processing is brought to a foreground of the output of the participant-computing device and the parent thread is sent to a background (step 870). The user of the participant-computing device may then independently access different portions of the presentation data from that being accessed by the presenter-computing device. Synchronization with the presenter-computing device is maintained by operation of the parent thread which is executing as a background operation (step 880).

A determination is made as to whether an input is received to return to synchronized access of the presentation data (step 890). If so, the child thread is torn down and a thread context switch is made to again bring the parent thread to the foreground of the execution in the participant-computing device (step 895).

Thereafter, or if no child thread needs to be spawned, a determination is made as to whether a stop condition has occurred, e.g., a stopping of the presentation (step 900). If so, the operation terminates. If not, the operation returns to step 840.

Thus, the present invention provides a mechanism for maintaining synchronization of access to portions of presentation data between a presenter-computing device and one or more participant-computing devices in an electronic conference. Moreover, the present invention provides a mechanism that permits independent accessing of portions of the presentation data locally in a participant-computing device while maintaining synchronization with a presenter-computing device. In this way, participants in an electronic conference may be free to access different portions of presentation data as they see fit and still be able to automatically return to the current portion of presentation data being accessed by a presenter.

It is important to note that while aspects of the present invention have been described in the context of a fully functioning data processing system, those of ordinary skill in the art will appreciate that processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for controlling access to presentation data during an electronic conference, comprising:
receiving, from a first computing device, a control signal indicating a first portion of the presentation data that is currently being accessed by the first computing device;
processing, in a first thread of execution, the control signal to synchronize access to a second portion of the presentation data on the data processing system with the first portion of the presentation data such that the first portion and second portion are the same portion of the presentation data; and
spawning, in response to a request for independent access of the presentation data, a second thread of execution, wherein independent access of the presentation data is provided via the second thread of execution while the first thread of execution continues to process control signals to synchronize access to the second portion of the presentation data.

2. The method of claim 1, wherein the presentation data is distributed to the data processing system prior to initiating the electronic conference.

3. The method of claim 1, wherein portions of the presentation data are distributed to the data processing system as the portions of the presentation data are accessed by the first computing device, and wherein the independent access of the presentation data is limited to those portions of the presentation data that have been received by the data processing system.

4. The method of claim 1, wherein the control signal identifies metadata corresponding to the first portion of presentation data being accessed by the first computing device on a copy of the presentation data remote from the data processing system, and wherein the control signal causes the same first portion of presentation data, on a copy of the presentation data local to the data processing system, to be accessed by the data processing system, based on metadata of the local copy of the presentation data to the data processing system.

5. The method of claim 1, further comprising:
receiving a user selection of a control for initiating a non-synchronized mode of operation on the data processing system; and
performing a thread context switch from the first thread of execution to the second thread of execution in response to receiving the user selection of the control for initiating a non-synchronized mode of operation, wherein spawning the second thread of execution is performed in response to the user selection of the non-synchronized mode of operation.

6. The method of claim 5, further comprising:
receiving a user input to return to a synchronized mode of operation;
performing a thread context switch from the second thread of execution to the first thread of execution in response to receiving the user input to return to a synchronized mode of operation; and
tearing down the second thread of execution.

7. The method of claim 5, further comprising:
receiving a synchronization control signal from the first computing device; and
performing a thread context switch from the second thread of execution to the first thread of execution in response to receiving the synchronization control signal from the first computing device.

8. The method of claim 1, further comprising:
receiving an inhibit control signal from the first computing device; and
preventing spawning of the second thread of execution in response to receiving the inhibit control signal.

9. The method of claim 1, wherein the data processing system is a participant computing device, and wherein the first computing device is a presenter computing device that controls the flow of the electronic conference.

10. The method of claim 1, wherein the presentation data is a plurality of electronic formatted presentation slides for use with the electronic conference.

11. A computer program product in a computer readable medium for controlling access to presentation data during an electronic conference, comprising:
instructions for receiving, from a first computing device, a control signal indicating a first portion of the presentation data that is currently being accessed by the first computing device;
instructions for processing, in a first thread of execution, the control signal to synchronize access to a second portion of the presentation data on the data processing system with the first portion of the presentation data such that the first portion and second portion are the same portion of the presentation data; and
instructions for spawning, in response to a request for independent access of the presentation data, a second thread of execution, wherein independent access of the presentation data is provided via the second thread of execution while the first thread of execution continues to process control signals to synchronize access to the second portion of the presentation data.

12. The computer program product of claim 11, wherein portions of the presentation data are distributed to the data processing system as the portions of the presentation data are accessed by the first computing device, and wherein the independent access of the presentation data is limited to those portions of the presentation data that have been received by the data processing system.

13. The computer program product of claim 11, wherein the control signal identifies metadata corresponding to the first portion of presentation data being accessed by the first computing device on a copy of the presentation data remote from the data processing system, and wherein the control signal causes the same first portion of presentation data, on a copy of the presentation data local to the data processing system, to be accessed by the data processing system, based on metadata of the local copy of the presentation data to the data processing system.

14. The computer program product of claim 11, further comprising:
instructions for receiving a user selection of a control for initiating a non-synchronized mode of operation on the data processing system; and
instructions for performing a thread context switch from the first thread of execution to the second thread of execution in response to receiving the user selection of the control for initiating a non-synchronized mode of operation, wherein the instructions for spawning the second thread of execution are executed in response to the user selection of the non-synchronized mode of operation.

15. The computer program product of claim 14, further comprising:
instructions for receiving a user input to return to a synchronized mode of operation;
instructions for performing a thread context switch from the second thread of execution to the first thread of execution in response to receiving the user input to return to a synchronized mode of operation; and
instructions for tearing down the second thread of execution.

16. The computer program product of claim 14, further comprising:
instructions for receiving a synchronization control signal from the first computing device; and
instructions for performing a thread context switch from the second thread of execution to the first thread of execution in response to receiving the synchronization control signal from the first computing device.

17. The computer program product of claim 11, further comprising:
instructions for receiving an inhibit control signal from the first computing device; and
instructions for preventing spawning of the second thread of execution in response to receiving the inhibit control signal.

18. The computer program product of claim 11, wherein the presentation data is a plurality of electronic formatted presentation slides for use with the electronic conference.

19. A system for controlling access to presentation data during an electronic conference, comprising:
an agent module;
a thread context management module coupled to the agent module; and
a synchronization module coupled to the agent module, wherein:
the agent module receives, from a first computing device, a control signal indicating a first portion of the presentation data that is currently being accessed by the first computing device,
the synchronization module processes, in a first thread of execution, the control signal to synchronize access to a second portion of the presentation data on the data processing system with the first portion of the presentation data such that the first portion and second portion are the same portion of the presentation data, and
the thread context management module spawns, in response to a request for independent access of the presentation data, a second thread of execution, wherein independent access of the presentation data is provided via the second thread of execution while the first thread of execution continues to process control signals to synchronize access to the second portion of the presentation data.

20. The system of claim 19, further comprising a graphical user interface for receiving a user selection of a control for initiating a non-synchronized mode of operation on the data processing system, wherein the thread context management module performs a thread context switch from the first thread of execution to the second thread of execution in response to receiving the user selection of the control for initiating a non-synchronized mode of operation, and wherein the thread context management module spawns the second thread of execution in response to the user selection of the non-synchronized mode of operation.
